(19) United States
(12) Patent Application Publication
(10) Pub. No.: US 2023/0206713 A1
(43) Pub. Date: Jun. 29, 2023

(54) VOTING MANAGEMENT SERVER AND VOTING MANAGEMENT PROGRAM

(71) Applicants: Gi Yong JANG, Seoul (KR); Eun Young PARK, Seoul (KR)

(72) Inventors: Gi Yong JANG, Seoul (KR); Eun Young PARK, Seoul (KR)

(21) Appl. No.: 18/178,384

(22) Filed: Mar. 3, 2023

Related U.S. Application Data
(63) Continuation of application No. PCT/KR2021/012395, filed on Sep. 13, 2021.

(30) Foreign Application Priority Data
Sep. 17, 2020 (KR) 10-2020-0119707

(51) Int. Cl. G07C 13/00; G06T 11/20

(52) U.S. Cl. CPC G07C 13/00; G06T 11/206

(57) ABSTRACT

A voting management server is provided. The voting management server may comprise: a participant status granting module for granting status as an inquirer to a participant who has requested to register a question, among a plurality of participants, and granting status as answerers to the remaining participants except for the inquirer; a chart generation module for generating, with regard to the question registered by the inquirer, a visually recognizable myriad answer-yield chart on the basis of a result with respect to answers that have been voted for by a plurality of the answerers, within an answer range which is configured by the inquirer and allows an answer including an irrational number and in which infinite numbers consecutively exist; and a voting result providing module for providing the generated myriad answer-yield chart to the participant who is willing to view same.

### CROSS-REFERENCE TO RELATED APPLICATIONS

This application is a continuation of Application No. PCT/KR2021/012395, filed on Sep. 13, 2021, which in turn claims the benefit of Korean Patent Application No. 10-2020-0119707, filed on Sep. 17, 2021. The entire disclosures of all these applications are hereby incorporated by reference.

### TECHNICAL FIELD

The present invention relates to a voting management server and a voting management program, and more specifically, to a voting management server and a voting management program, which can allow decision-making values including irrational numbers in a reference range in which infinite numbers consecutively exist and can provide a visually recognizable voting result including a small number of decision-making values.

### BACKGROUND ART

In the future, it will be necessary to analyze answers expressed in irrational numbers in addition to answers with a very small occurrence frequency for one question having infinite areas as an answer range.

For example, individual decision-making may be investigated using dichotomy (black and white) such as “good” or “bad”, or a patient’s pain may be investigated using a 5-point Likert scale question such as “very sick”, “a little sick”, “moderate”, “good”, and “very good”.

However, such a multiple choice question may deteriorate the autonomy of answerers, and may interfere with the possibility of the answer that may be expressed in the irrational number which is present between 1 to 5 points such as square root 2 (√2) or n.

On the contrary, when a reference range is set infinitely large in order to ask a question about an individual’s taste or an answer is allowed to be expressed in myriad values between 0 and 1, values provided on an x-axis by a small number of answerers may be distributed infinitely far within the reference range, and since there is a possibility that an occurrence frequency of each value may be one time, it may be difficult to visualize the values in the form of a chart in which the occurrence frequency is cumulatively marked on a y-axis.

### DISCLOSURE

### Technical Problem

One technical problem to be solved by the present invention is to provide a voting management server and a voting management program, which can allow decision-making values including irrational numbers in a reference range in which infinite numbers consecutively exist, and can provide a visually recognizable voting result including a small number of decision-making values.

Another technical problem to be solved by the present invention is to provide a voting management server and a voting management program, which enable sharing of profits between an inquirer, an answerer, and an answer purchaser.

The technical problems to be solved by the present invention are not limited to those described above.

### Technical Solution

To solve the above technical problem, the present invention provides a voting management server.

According to one embodiment, a vote management server may include: a participant status granting module for granting status as an inquirer to a participant who has requested to register a question, among a plurality of participants, and granting status as answerers to the remaining participants except for the inquirer; a chart generation module for generating, with regard to the question registered by the inquirer, a visually recognizable myriad answer-yield chart on the basis of a result with respect to answers that have been voted for by a plurality of the answerers, within an answer range which is configured by the inquirer and allows an answer including an irrational number and in which infinite numbers consecutively exist; and a voting result providing module for providing the generated myriad answer-yield chart to the participant who is willing to view same.

According to one embodiment, the chart generation module may divide the answer range into a plurality of first sections having a same interval in one direction by equally dividing the answer range, and when at least one answer belongs to any one of the first sections, the chart generation module may display a first occupied area, both ends of which are defined by a numerically highest-level answer and a numerically lowest-level answer, in a corresponding first section, and may further display representative value positions of answers included in the first occupied area or a concentration degree of answers indicating a distribution of the answers included in the first occupied area in the first occupied area.

According to one embodiment, the chart generation module may designate, as an X-axis of the myriad answer-yield chart, the plurality of first sections in which the first occupied area is displayed in at least one first section, may designate, as a Y-axis of the myriad answer-yield chart, an occurrence frequency of the answers included in the first occupied area, and may schematize the representative value positions of the answers as a graph by connecting the representative value positions of the answers included in each of the first occupied areas.

According to one embodiment, the chart generation module may further generate an enlarged myriad answer-yield chart for the first occupied area, and may divide the first occupied area into a plurality of second sections having a same interval in one direction by equally dividing the first occupied area, and when at least one answer belongs to any one of the second sections, the chart generation module may display a second occupied area, both ends of which are defined by a numerically highest-level answer and a numerically lowest-level answer in a corresponding second area, in the second section, and may further display representative value positions of answers included in the second occupied area or a concentration degree of answers indicating a distribution of the answers included in the second occupied area, in the second occupied area.

According to one embodiment of the present invention, the voting management server may further include a point settlement module, wherein the point settlement module may include: an inquirer point settlement unit that subtracts cashable points from a point account of the inquirer who has the status granted by the participant status granting module according to set criteria; an answerer point settlement unit that accumulates the cashable points in a point account of the answerer who has registered the answer to the question according to the set criteria; and an answer purchaser point settlement unit that subtracts the cashable points from a point account of the participant who has requested to view the myriad answer-yield chart provided by the voting result providing module according to the set criteria, and accumulates the cashable points in the point account of the inquirer in proportional to the subtracted cashable points.

According to one embodiment, the voting result providing module may provide the myriad answer-yield chart to the participant who has requested to view the myriad answer-yield chart, when settlement has been completed by the answer purchaser point settlement unit.

Meanwhile, the present invention provides a voting management program.

According to one embodiment, the voting management program stored in a medium, the voting management program may execute: a log-in step of performing, by a log-in unit, log-in of a participant who has registered as a member by downloading and installing a dedicated application provided from a server; a participant status granting step of granting, by a participant status granting unit, status as an inquirer to the participant who has requested to register a question, among a plurality of participants, and granting status as an answerer to remaining participants except for the inquirer; a chart generation step of generating, by a chart generation unit, with regard to the question registered by the inquirer, a visually recognizable myriad answer-yield chart on the basis of a result with respect to answers that have been voted for by a plurality of the answerers, within an answer range which is configured by the inquirer and allows an answer including an irrational number and in which infinite numbers consecutively exist; and a voting result providing step of providing, by a voting result providing unit, the generated myriad answer-yield chart to the participant who is willing to view same.

### ADVANTAGEOUS EFFECTS

According to one embodiment of the present invention, it is possible to include: a participant status granting module for granting status as an inquirer to a participant who has requested to register a question, among a plurality of participants, and granting status as answerers to the remaining participants except for the inquirer; a chart generation module for generating, with regard to the question registered by the inquirer, a visually recognizable myriad answer-yield chart on the basis of a result with respect to answers that have been voted for by a plurality of the answerers, within an answer range which is configured by the inquirer and allows an answer including an irrational number and in which infinite numbers consecutively exist; and a voting result providing module for providing the generated myriad answer-yield chart to the participant who is willing to view same.

Accordingly, it is possible to provide a voting management server and a voting management program, which can allow decision-making values including irrational numbers in a reference range in which infinite numbers consecutively exist and can provide a visually recognizable voting result including a small number of decision-making values, thereby easily recognizing distributed decision-making values, that is, answers.

In addition, according to the embodiment of the present invention, it is possible to provide a voting management server and a voting management program, which enable sharing of profits between an inquirer, an answerer, and an answer purchaser.

### DESCRIPTION OF DRAWINGS

FIG. 1 is a configuration diagram showing a voting management server according to one embodiment of the present invention.

FIG. 2 is a first exemplary diagram for describing an interface providing module that provides a question window to a question terminal in the voting management server according to one embodiment of the present invention.

FIG. 3 is an exemplary diagram for describing a point settlement module for guiding point settlement to an inquirer terminal in a voting management server according to one embodiment of the present invention.

FIG. 4 is a second exemplary diagram for describing an interface providing module that provides a question window to an inquirer terminal in the voting management server according to one embodiment of the present invention.

FIG. 5, FIG. 6 and FIG. 7 are exemplary diagrams for describing an interface providing module that provides an answer window to an answerer terminal in the voting management server according to one embodiment of the present invention.

FIG. 8 is an exemplary diagram for describing a point settlement module for guiding point settlement to an answerer terminal in the voting management server according to one embodiment of the present invention.

FIG. 9, FIG. 10 and FIG. 11 are reference diagrams for describing a chart generation module for generating a myriad answer-yield chart in the voting management server according to one embodiment of the present invention.

FIGS. 12 and 13 are exemplary diagrams for describing a voting result providing module for providing a result window to an answer purchaser terminal in the voting management server according to one embodiment of the present invention.

FIG. 14 is an exemplary diagram for describing a point settlement module for guiding point settlement to an answer purchaser terminal in the voting management server according to one embodiment of the present invention.

FIG. 15 is a flowchart sequentially showing steps in which a voting management program according to one embodiment of the present invention is executed.

FIGS. 16A and 16B are a reference diagram for describing a flow of points when the voting management program according to one embodiment of the present invention is executed.

### MODE FOR INVENTION

Hereinafter, preferred embodiments of the present invention will be described in detail with reference to the accompanying drawings. However, the present invention may be embodied in different forms and should not be construed as limited to the embodiments set forth herein. Rather, the embodiments are provided so that this disclosure will be thorough and complete, and will fully convey the scope of the present invention to those skilled in the art.

In the present specification, it will be understood that when an element is referred to as being “on” another element, it can be formed directly on the other element or intervening elements may be present. In the drawings, the shapes and sizes are exaggerated for clarity.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Embodiments explained and illustrated herein include their complementary counterparts. As used herein, the term “and/or” includes any and all combinations of one or more of the associated listed elements.

The singular expression also includes the plural meaning as long as it does not differently mean in the context. In addition, the terms “comprise”, “have” etc., of the description are used to indicate that there are features, numbers, steps, elements, or combinations thereof, and they should not exclude the possibilities of combination or addition of one or more features, numbers, operations, elements, or a combination thereof. Furthermore, it will be understood that when an element is referred to as being “connected” or “coupled” to another element, it may be directly connected or coupled to the other element or intervening elements may be present.

In addition, when detailed descriptions on related known functions or constitutions are considered to unnecessarily cloud the gist of the present invention in describing the present invention below, the detailed descriptions will not be included.

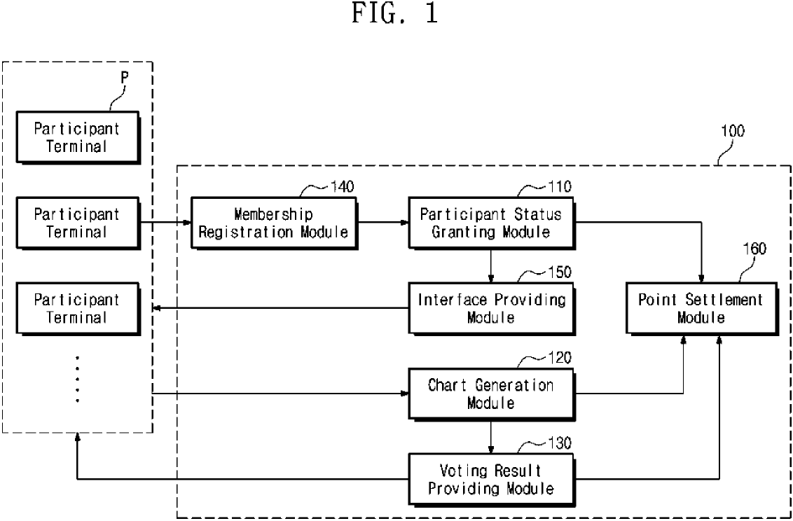

FIGS. 1 to 14 are diagrams for describing a voting management server according to one embodiment of the present invention.

As shown in FIG. 1, a voting management server 100 according to one embodiment of the present invention may include a participant status granting module 110, a chart generation module 120, and a voting result providing module 130.

The participant status granting module 110 may grant status as an inquirer to a participant who has requested to register a question, among a plurality of participants. In this case, the inquirer who has the status granted by the participant status granting module 110 may register the question by paying points required for the question registration, which will be described below in more detail.

In addition, the participant status granting module 110 may grant status as an answerer to remaining participants except for the inquirer among the plurality of participants. In this case, the participant who has the status as an inquirer granted by the participant status granting module 110 may have status as an answerer with respect to a question of another inquirer.

Meanwhile, the participant status granting module 110 may grant status as an answer purchaser to a participant who wants to additionally receive a myriad answer-yield chart, which will be described later, among participants who have requested to view answers that have been voted for by a plurality of answerers with regard to the question registered by the inquirer among the plurality of participants. In this case, the answer purchaser receives the myriad answer-yield chart by paying points set in the myriad answer-yield chart, which will be described below in more detail.

In one embodiment of the present invention, the participant may download and install a dedicated application provided from the voting management server 100 on a terminal P, and may be defined as a member who has status granted by the voting management server 100.

Accordingly, the voting management server 100 according to one embodiment of the present invention may further include a membership registration module 140 in order to recruit and manage subjects who want to participate in the voting.

The membership registration module 140 receives and stores personal information by membership registration of the subjects who want to participate in the voting.

To this end, the membership registration module 140 may include a membership database for storing personal information of the subjects. Subjects who want to participate in the voting have status as participants when the subjects agree to use personal information upon membership registration through the membership registration module 140.

Accordingly, the voting management server 100 according to one embodiment of the present invention may provide information about the voting suitable for each participant, for example, alarm or notification about a question type, a participation time, the number of participants, compensation, etc., to the terminal P of the corresponding participant in the form of a message or pop-up window, by using personal information, such as a region, an age, a name, a sex, and a preference of the participants collected through the membership registration module 140.

Referring to FIG. 1, the voting management server 100 according to one embodiment may further include an interface providing module 150. The interface providing module 150 may be provided to register a question of an inquirer and answer registration of an answerer to the question.

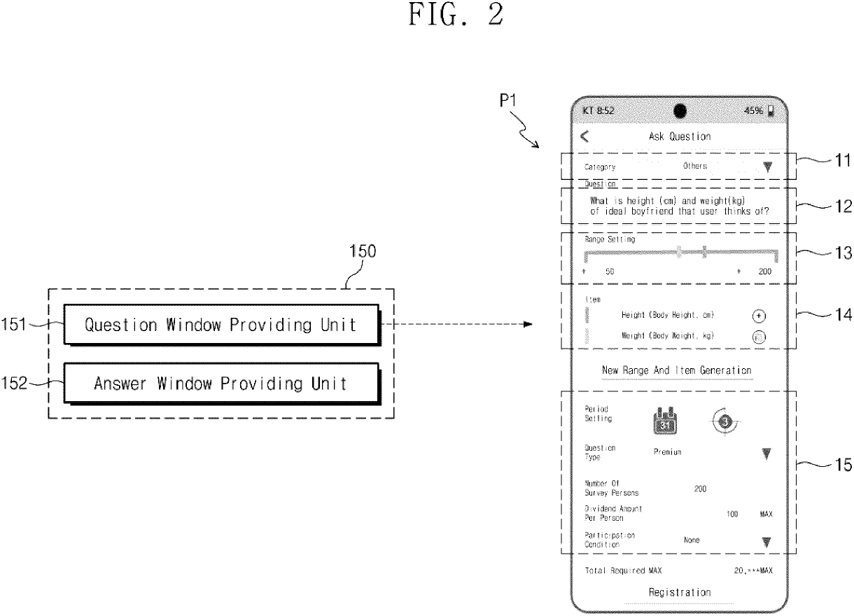

To this end, referring to FIG. 2, the interface providing module 150 according to one embodiment of the present invention may include a question window providing unit 151.

The question window providing unit 151 may provide a question window to the inquirer terminal P1. The question window provided to the inquirer terminal P1 by the question window providing unit 151 may include a question category section 11, a question section 12, an answer range setting section 13, an answer item setting section 14, and a question condition setting section 15.

The question category section 11 enables selection of a question field, and the question section 12 enables input of a question to be registered.

The answer range setting section 13 may be provided in the form of a scroll bar. The answer range setting section 13 may allow setting of a minimum value and a maximum value in an infinite range including a positive number, a negative number, and an irrational number. The answer item setting section 14 enables setting of an item to be answered.

For example, when the question registered through the question section 12 is “what is the height (cm) and weight (kg) of the ideal boyfriend that the user thinks of?”, the answer item setting section 14 may set “height” and “weight” as answer items. Accordingly, the answerer to the question may only answer “height” and “weight”.

The answer item setting section 14 basically exposes one answer item, and the answer item may be added or deleted by the inquirer.

The question condition setting section 15 enables setting of an answer period for a question. Accordingly, the inquirer may select the answer period as any one of a calendar form and a countdown form. Further, the question condition setting section 15 enables setting of “question type”, “number of survey persons”, and “dividend amount per person” for answerers.

In one embodiment of the present invention, the inquirer may register the question by paying the retained points.

Accordingly, referring to FIG. 1, the voting management server 100 according to one embodiment of the present invention may further include a point settlement module 160.

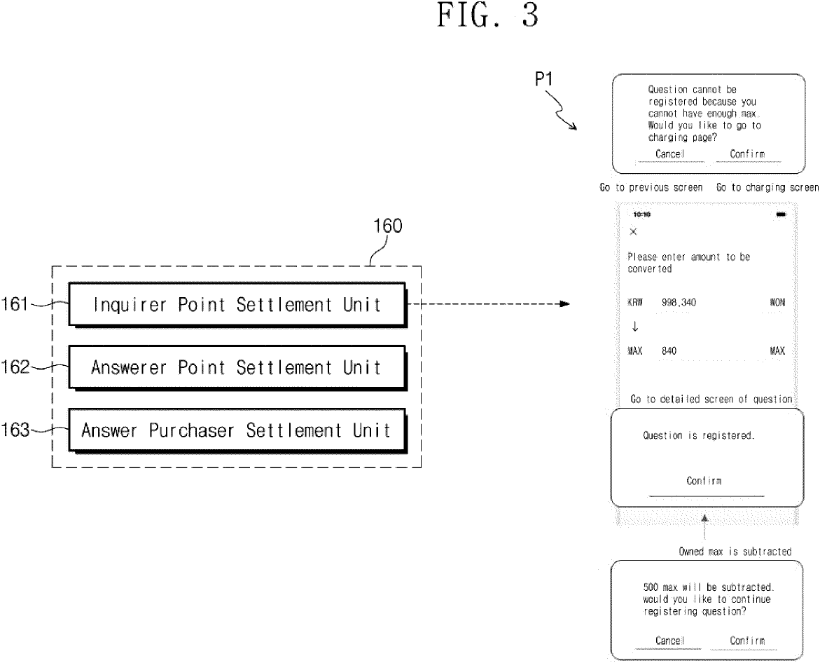

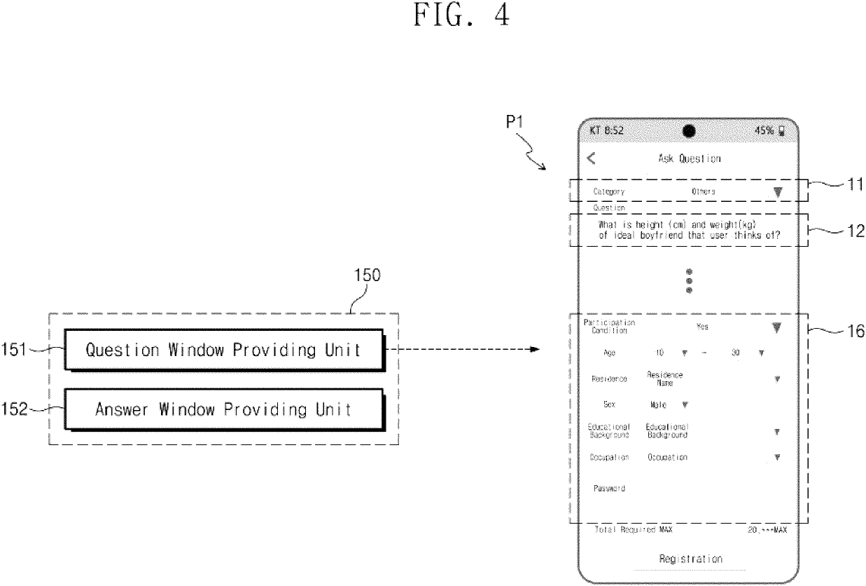

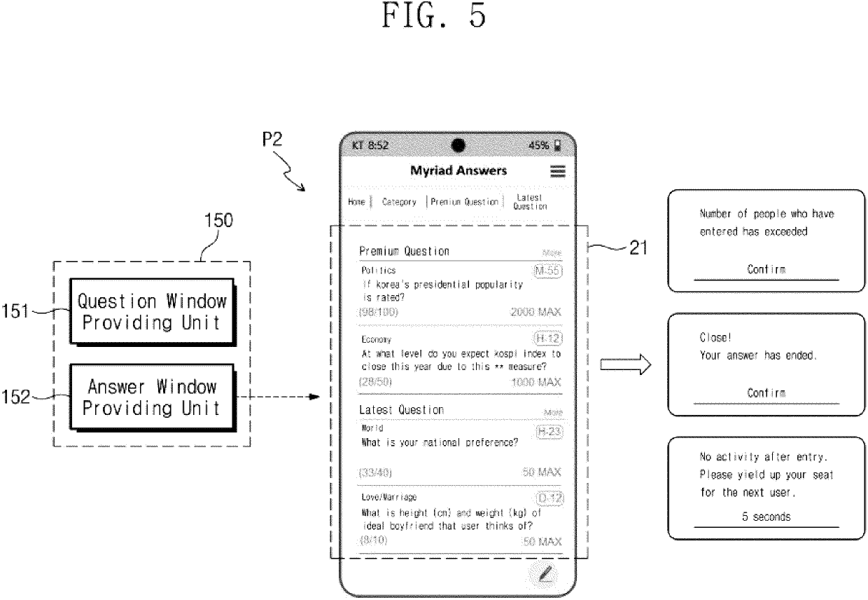

As shown in FIG. 3, the point settlement module 160 may include an inquirer point settlement unit 161.

The inquirer point settlement unit 161 may subtract cashable points from a point account of the inquirer who has inquirer status granted by the participant status granting module 110, according to a setting standard. For example, when “the number of survey persons” is 200 and the “dividend amount per person” is 100 MAX (points), the inquirer point settlement unit 161 may subtract 20,000 MAX from the point account of the inquirer. In this case, the inquirer point settlement unit 161 may subtract the corresponding points from the point account of the inquirer when the answer is made by the answerer and the payment for the dividend amount per person is requested.

The inquirer point settlement unit 161 may provide a point charging window to the inquirer terminal P1 when the retained points of the inquirer are insufficient.

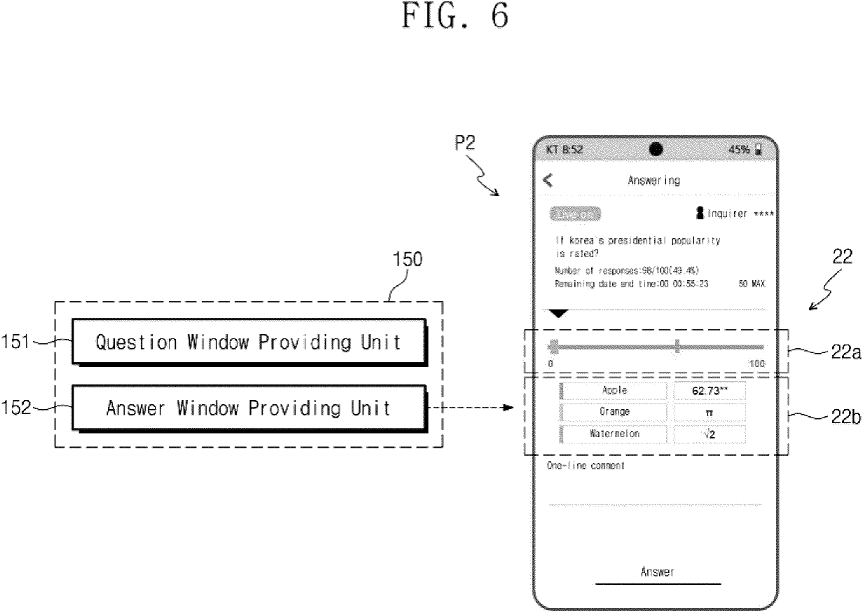

Meanwhile, referring to FIG. 4, the question window providing unit 151 may further include a participation condition setting section 16. The participation condition setting section 16 enables setting of “participation condition”, “age”, “residence”, “sex”, “educational background”, “occupation”, “password”, etc. When the setting is made that the inquirer has the participation condition, setting items such as “age”, “residence”, “sex”, “educational background”, “occupation”, and “password” may be exposed on the question window.

In this way, the participation condition is set through the participation condition setting section 16, so that the inquirer may share, for example, questions and passwords with acquaintances, and may proceed with a closed vote on sensitive issues or private or confidential issues.

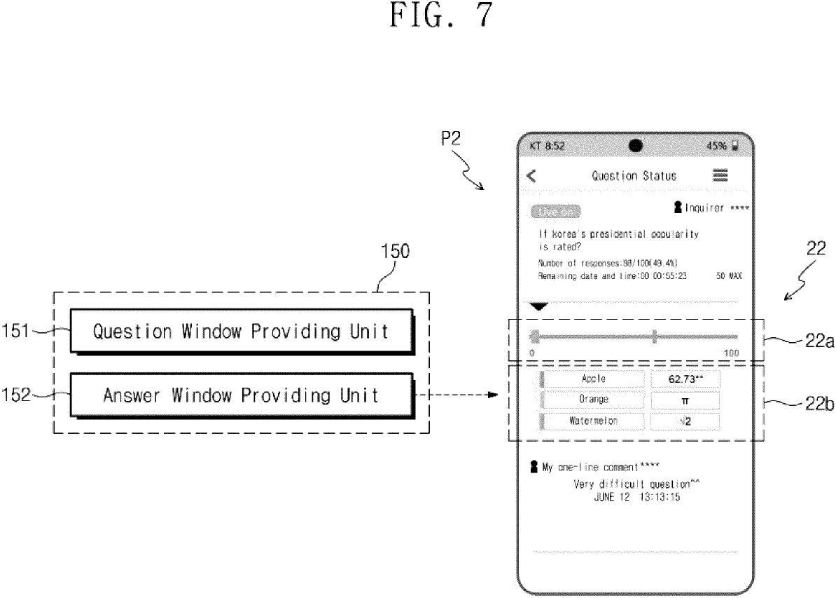

In addition, referring to FIG. 5, the interface providing module 150 according to one embodiment of the present invention may further include an answer window providing unit 152 in order to register the answers of the answerer.

The answer window providing unit 152 may provide an answer window to an answerer terminal P2. The answer window provided to the answerer terminal P2 by the answer window providing unit 152 may include a question item section 21.

The question item section 21 may display a representative question for each field among, for example, a “premium question” item and a “latest question” item. In addition, the question item section 21 may display an answer period, a dividend amount, a participation status, and the like of the representative question. In this case, when the answerer clicks on any question item, the question item section 21 may provide a guide message such as “Number of people who have entered has exceeded” and “Close! Your answer has ended.” and “No activity after entry. Please yield up your seat for the next user.”

Further, referring to FIGS. 6 and 7, the answer window may display an answer section 22. The answer section 22 may include a scroll bar 22a and a number window 22b, which indicate an answer range set by the inquirer. When the answerer selects a valid question in the question item section 21, the answer window is switched from the question item section 21 to the answer section 22. Accordingly, the answerer may scroll the scroll bar 22a within the answer range set by the answerer and move the scroll bar 22a to a desired position. In this case, a number indicated by the moved scroll bar 22a may be displayed on the number window 22b. In this case, a number having representativeness of a position where the scroll bar 22a is moved may be displayed on the number window 22b.

In addition, the answerer may input a desired value into the number window 22b within the answer range set by the inquirer. The answerer may input not only a number having a decimal point that may exist in the answer range set by the inquirer, but also an irrational number such as a square root (√2) of 2 and n. In this case, the value may be calculated through a provided engineering calculator.

That is, the answerer may input an equation through the engineering calculator and input a value extracted therefrom as a value for the answer. In this case, the scroll bar 22a may be moved by interlocking with the answer value input to the number window 22b. In this case, the scroll bar 22a may be moved to a position having representativeness for the value input into the number window 22b.

As described above, when the corresponding question is answered through the answer window provided by the answer window providing unit 152, the answerer may receive the dividend amount set by the inquirer as cashable points. As described above, the voting management server 100 according to one embodiment of the present invention compensates for the answers, thereby increasing an answer participation rate and obtaining various and high-quality voting results.

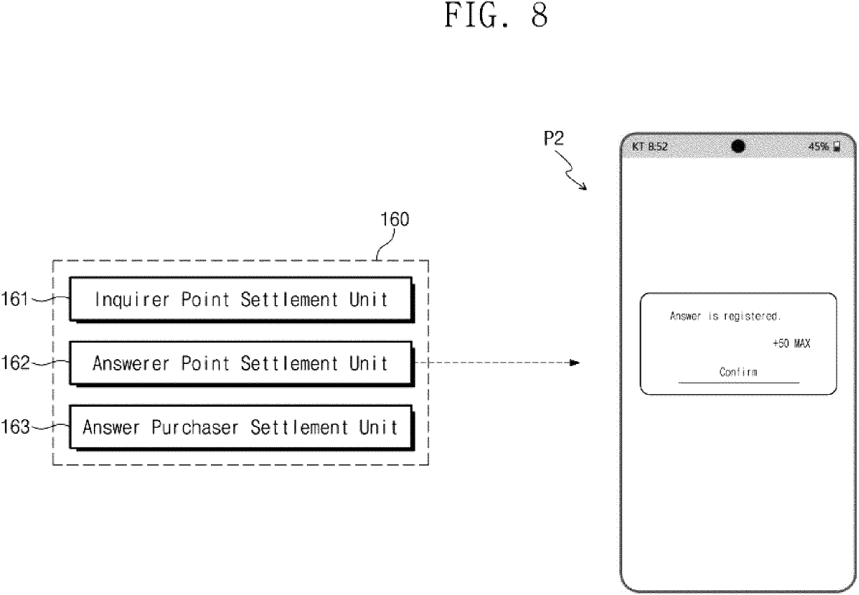

Referring to FIG. 8, the point settlement module 160 according to one embodiment of the present invention may further include an answerer point settlement unit 162.

The answerer point settlement unit 162 may accumulate cashable points in a point account of an answerer who has registered an answer to a question according to set criteria. For example, when the dividend amount set by the inquirer with respect to the corresponding question is “50 MAX” points, the answerer point settlement unit 162 registers an answer when the answer input has been completed by the answerer. When a message “+50 MAX” is displayed on the answer window and the answerer confirms the message, the cashable points “50 MAX” may be accumulated in the point account of the answerer. At the same time, the inquirer point settlement unit 161 may subtract points from the point account of the inquirer as much as the points accumulated in the point account of the answerer.

Referring back to FIG. 1, the chart generation module 120 may generate, with regard to the question registered by the inquirer, a visually recognizable myriad answer-yield chart on the basis of a result with respect to answers that have been voted for by a plurality of the answerers, within an answer range which is configured by the inquirer and allows an answer including an irrational number and in which infinite numbers consecutively exist.

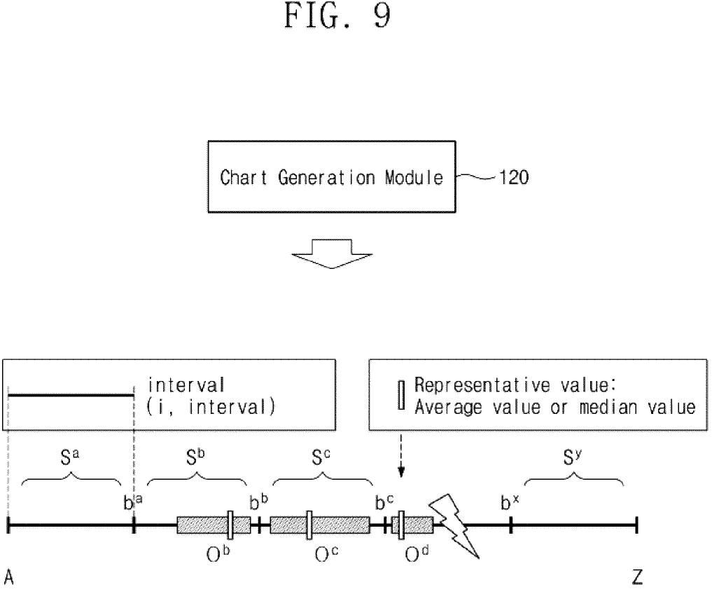

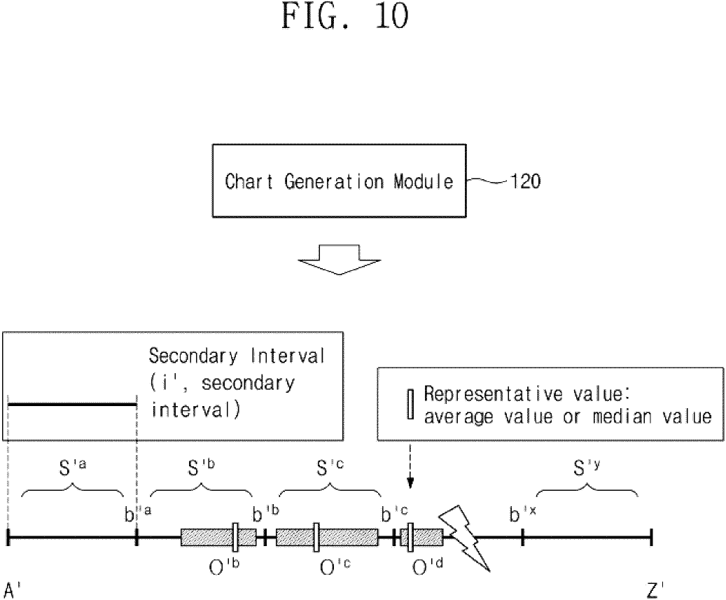

Referring to FIG. 9, when the answer range is set to a range from A to Z by the inquirer, first, the chart generation module 120 may equally divide the answer range into intervals i to divide the answer range into a plurality of first sections S^{a}, S^{b}, S^{c}, ..., S^{y} having the same interval i in one direction. In this case, S^{a} and S^{b} may be defined as a boundary point b^{a}, S^{b} and S^{c} may be defined as a boundary point b^{b}, S^{c} and S^{d} may be defined as a boundary point b^{c}, and S^{x} and S^{y} may be defined as a boundary point b^{x}.

Next, when the at least one answer belongs to any one of the plurality of first sections S^{a}, S^{b}, S^{c}, ..., S^{y}, the chart generation module 120 may display a first occupied area, both ends of which are defined by the numerically highest-level answer and the numerically lowest-level answer in the corresponding first section, in the corresponding first section.

For example, when the answers belong to the first section S^{b}, the chart generation module 120 may display a first occupied area O^{b}, both ends of which are defined by the numerically highest-level answer and the numerically lowest-level answer among the answers belonging to the first section S^{b}, in the first section S^{b}.

In addition, when the answers belong to the first section S^{c}, the chart generation module 120 may display a first occupied area O^{c}, both ends of which are defined by the numerically highest-level answer and the numerically lowest-level answer among the answers belonging to the first section S^{c}, in the first section S^{c}.

In addition, when the answers belong to the first section S^{d}, the chart generation module 120 may display a first occupied area O^{d}, both ends of which are defined by the numerically highest-level answer and the numerically lowest-level answer among the answers belonging to the first section S^{d}, in the first section S^{d}.

Next, the chart generation module 120 may further display, in the corresponding first occupied area, the representative value positions of the answers included in the corresponding first occupied area. The representative value of the answers described herein may be an average value or a median value of the answers. In this case, the chart generation module 120 may display the representative value positions of the answers in the form of a bar.

In addition, the chart generation module 120 may further display a concentration degree of answers indicating a distribution of answers included in the corresponding first occupied area, in the first occupied area.

Referring to FIG. 11, the chart generation module 120 may designate the plurality of first sections in which the first occupied area is displayed in at least one first section, that is, the answer range set by the inquirer, as an X-axis of the myriad answer-yield chart, and may designate an occurrence frequency of answers included in the first occupied area, for example, the number of answerers or an answer rate, as a Y-axis of the myriad answer-yield chart. For example, in a question asking the preference for “apple”, the chart generation module 120 may designate the answer range “0 to 1” set by the inquirer as the X-axis, and designate the number of the inquirers for the question asking the preference for “apple” as the Y-axis. Accordingly, the first occupied area may be displayed at a position where the corresponding first section meets the occurrence frequency on a two-dimensional graph consisting of the X-axis and the Y-axis.

Finally, the chart generation module 120 may schematize the representative value positions of the answers as a linear graph by connecting the representative value positions of the answers included in each of the first occupied areas.

In this case, although not shown, the chart generation module 120 may generate a three-dimensional myriad answer-yield chart by designating the age, educational background, region, etc. of the answerer as a Z-axis. As described above, when the three-dimensional myriad answer-yield chart is generated, more information about the voting results may be intuitively recognized at a time, and accordingly, it is possible to more easily analyze the voting results.

Meanwhile, referring to FIG. 10, the chart generation module 120 may further generate an enlarged myriad answer-yield chart for the first occupied area.

The chart generation module 120 may equally divide the first occupied area into intervals I′ to divide the first occupied area into a plurality of second sections S′^{a}, S′^{b}, S′^{c}, ..., S′^{y} having the same interval I′ in one direction. In this case, S′^{a} and S′^{b} may be defined as a boundary point b′^{a}, S′^{b} and S′^{c} may be defined as a boundary point b′^{b}, S′^{c} and S’^{d} may be defined as a boundary point b′^{c}, and S′^{x} and S′^{y} may be defined as a boundary point b′^{x}.

Next, when the at least one answer belongs to any one of the plurality of second sections S′^{a}, S′^{b}, S′^{c}, ..., S′^{y}, the chart generation module 120 may display a second occupied area, both ends of which are defined by the numerically highest-level answer and the numerically lowest-level answer, in the corresponding second section.

For example, when the answers belong to the second section S′^{b}, the chart generation module 120 may display a second occupied area O′^{b}, both ends of which are defined by the numerically highest-level answer and the numerically lowest-level answer among the answers belonging to the second section S′^{b}, in the second section S′^{b}.

In addition, when the answers belong to the second section S′^{c}, the chart generation module 120 may display a second occupied area O′^{c}, both ends of which are defined by the numerically highest-level answer and the numerically lowest-level answer among the answers belonging to the second section S′^{c}, in the second section S′^{c}.

In addition, when the answers belong to the second section S’^{d}, the chart generation module 120 may display a second occupied area O’^{d}, both end of which are defined by the numerically highest-level answer and the numerically lowest-level answer among the answers belonging to the second section S’^{d}, in the second section S’^{d}.

Next, the chart generation module 120 may further display the representative value positions of the answers included in the corresponding second occupied area, in the corresponding second occupied area. The representative value of the answers described herein may be an average value or a median value of the answers. In this case, the chart generation module 120 may display the representative value positions of the answers in the form of a bar.

In addition, the chart generation module 120 may further display a concentration degree of answers indicating a distribution of answers included in the corresponding second occupied area, in the second occupied area.

Similar to a case of generating the myriad answer-yield chart, the chart generation module 120 may designate the plurality of second sections in which the second occupied area is displayed in at least one second sections as an X-axis of the enlarged myriad answer-yield chart, and may designate the occurrence frequency of answers included in the second occupied area as a Y-axis of the enlarged myriad answer-yield chart. Accordingly, the second occupied area may be displayed at a position where the corresponding second section meets the occurrence frequency on a two-dimensional graph consisting of the X-axis and the Y-axis.

Finally, the chart generation module 120 may schematize the representative value positions of the answers as a linear graph by connecting the representative value positions of the answers included in each of the second occupied areas, and may generate a three-dimensionally enlarged myriad answer-yield chart by designating the age, educational history, region, and the like of the answerer as a Z-axis.

As described above, the chart generation module 120 displays the first occupied areas or the second occupied areas, which are n sectional occupied areas, in the corresponding section, and further displays answer values, which have the occurrence frequency of 0 or 1 and are distributed in a defined area in which values of infinite numbers may exist, in an occupied area having representativeness on a multi-partition axis, thereby easily recognizing the answer distributed even when the occurrence frequency of the answer value on the X-axis does not exceed 1.

Referring back to FIG. 1, the voting result providing module 130 may provide the myriad answer-yield chart generated by the chart generation module 120 to a participant who is willing to view the same. In this case, the voting result providing module 130 may provide the myriad answer-yield chart to the inquirer. In addition, the voting result providing module 130 may provide the myriad answer-yield chart to an answer purchaser.

Referring to FIG. 11, the voting result providing module 130 may selectively provide the myriad answer-yield chart according to point settlement of the answer purchaser. For example, even when the participant who is willing to view the voting result does not pay points for purchasing an answer, the voting result providing module 130 may provide an answer distribution diagram showing a simple answer distribution as shown in FIG. 11(a) to the participant terminal P.

On the other hand, when the participant who is willing to view the myriad answer-yield chart, that is, the answer purchaser, settles points for purchasing an answer, the voting result providing module 130 may provide the myriad answer-yield chart generated by the chart generation module 120 as shown in FIG. 11(b) to an answer purchaser terminal P3.

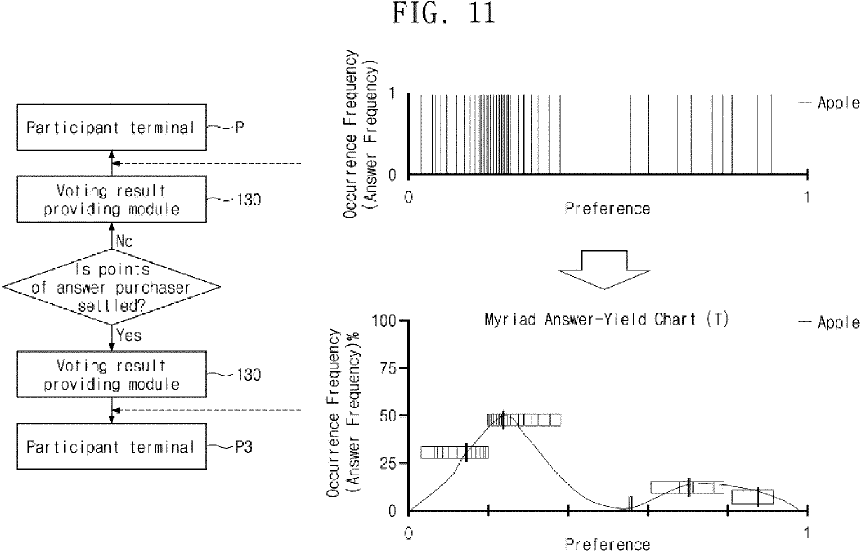

Referring to FIG. 12, to this end, the voting result providing module 130 may provide a result window to the answer purchaser terminal P3.

The result window provided to the answer purchaser terminal P3 by the voting result providing module 130 may include a result list section 31.

The result list section 31 may display, for example, questions belonging to a category “politics” and questions belonging to a category “economy”. In this case, the result list section 31 may display an ending state of the corresponding question (e.g., Live off), an ending date and time, etc.

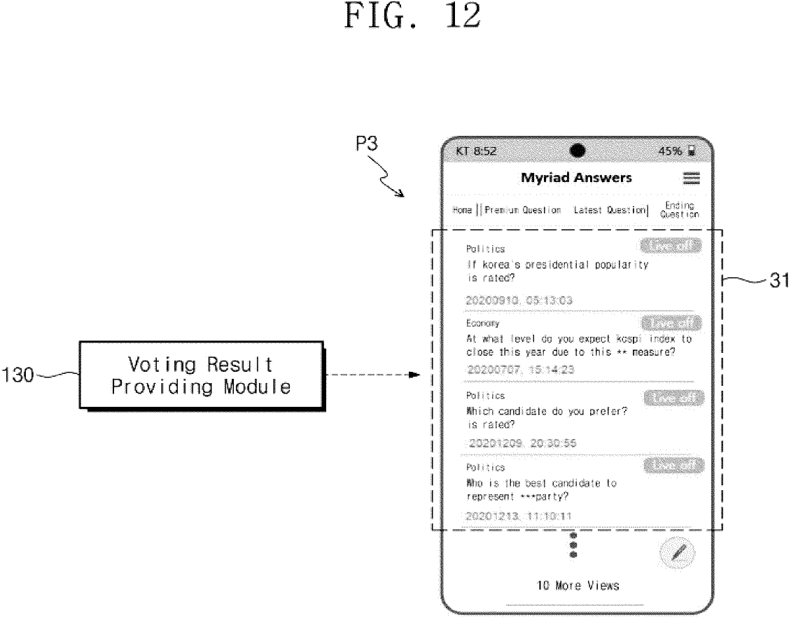

Referring to FIG. 13, when the answer purchaser selects, for example, a question result “If Korea’s presidential popularity is rated” in the result list section 31, the result window is switched from the result list section 31 to the result display section 32.

A “current state of a question”, an “inquirer”, a “question content”, a “number of responses”, an “answer period”, a “dividend amount”, etc., which indicate progress or end, may be displayed at an upper end of the result window in which the result display section 32 is displayed.

In the result display section 32, a download icon for downloading raw data about an answer result to the question or the myriad answer-yield chart generated based on the raw data may be activated. In addition, the result display section 32 may display an average value and a ranking for each answer item voted by the answerer. In this case, an icon capable of selecting on/off may be activated in each answer item. Accordingly, the answer purchaser turns on/off the icon for each item, thereby viewing only a desired result.

A myriad answer-yield chart T generated by the chart generation module 120 may be displayed in the result display section 32. In this case, only the answer value of the item, which is turned on by the answer purchaser, may be displayed in the myriad answer-yield chart T. Accordingly, the answer purchaser may intuitively analyze and grasp a desired voting result.

Meanwhile, a “one-line comment” may be displayed at a lower end of the result display section 32. In the “one-line comment”, an ID of an answerer who has answered the corresponding question, content of a comment, a date of comment registration, and the like may be displayed.

Meanwhile, when payment for the answer result has been completed, the result window may be switched from the result list section 31 to the result display section 32.

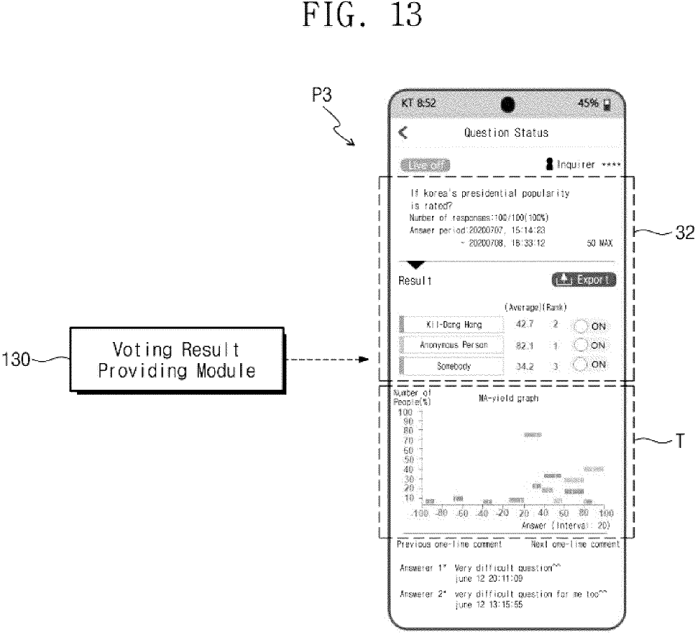

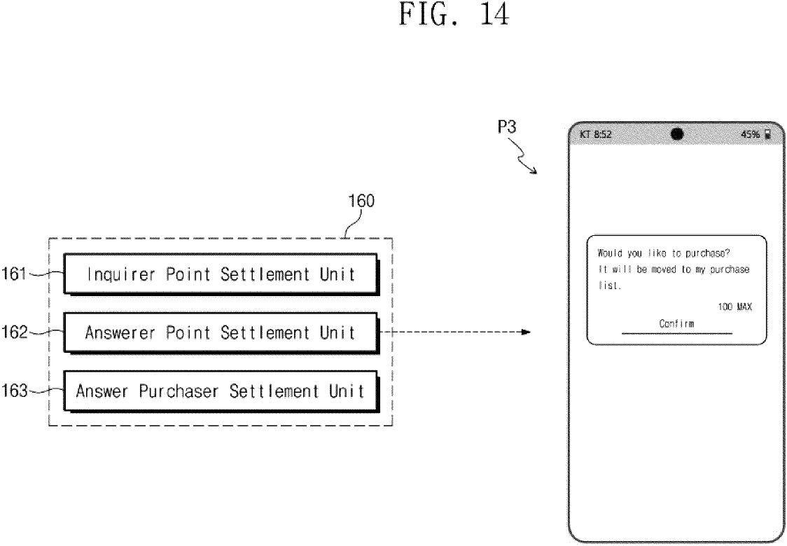

Therefore, referring to FIG. 14, the point settlement module 160 according to one embodiment of the present invention may further include an answer purchaser point settlement unit 163.

The answer purchaser point settlement unit 163 may subtract cashable points from a point account of a participant who has requested to view the myriad answer-yield chart provided by the voting result providing module 130, that is, from a point account of an answer purchaser, according to criteria set for answer purchase, For example, when the answer purchaser selects a result for any one question in the result list section 31 provided in the result window, the answer purchaser point settlement unit 163 may display a message such as “Do you want to purchase? Go to my purchase list. 100 MAX” on the result window. When the answer purchaser clicks or touches “confirm”, the answer purchaser point settlement unit 163 may subtract 100 MAX points from the point account of the answer purchaser. In this case, the answer purchaser point settlement unit 163 may accumulate 100 MAX cashable points in the point account of the inquirer in proportion to the subtracted cashable points.

In one embodiment of the present invention, the inquirer pays the cashable points when registering a question. In addition, the answerer obtains cashable points when registering an answer. In addition, the answer purchaser pays the cashable points when purchasing the answer. In this case, some or all of the cashable points paid by the answer purchaser for purchasing the answer may be paid to the inquirer.

As described above, the voting management server 100 according to one embodiment of the present invention may enable sharing of profits between the inquirer, the answerer, and the answer purchaser. That is, the voting management server 100 according to one embodiment of the present invention may establish a profit virtuous cycle structure between the inquirer, the answerer, and the answer purchaser.

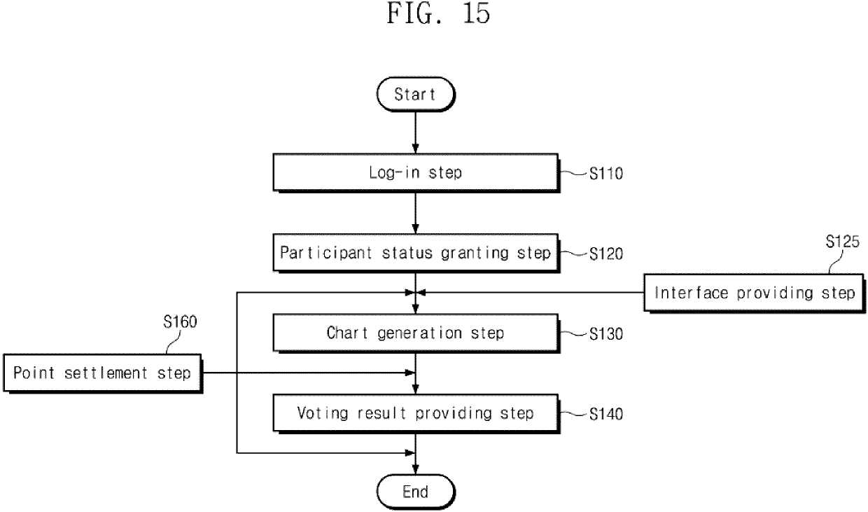

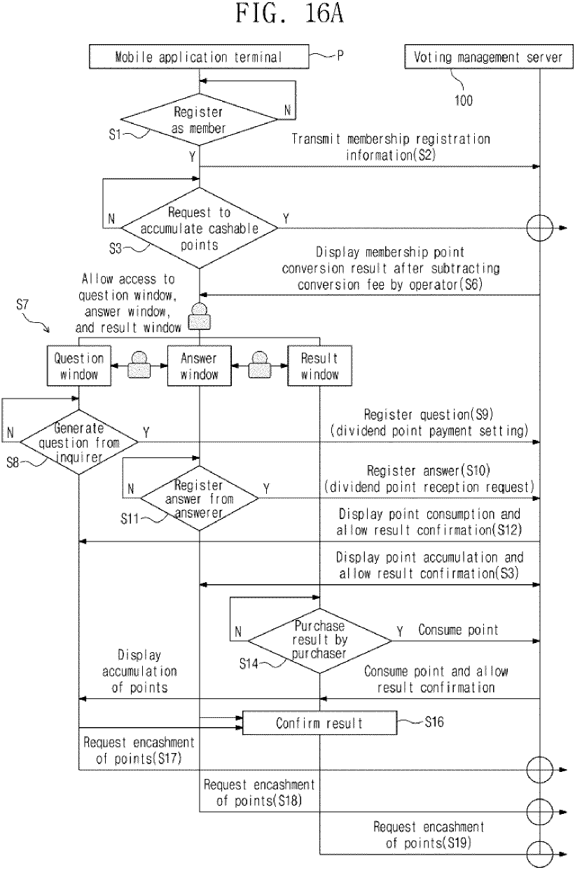

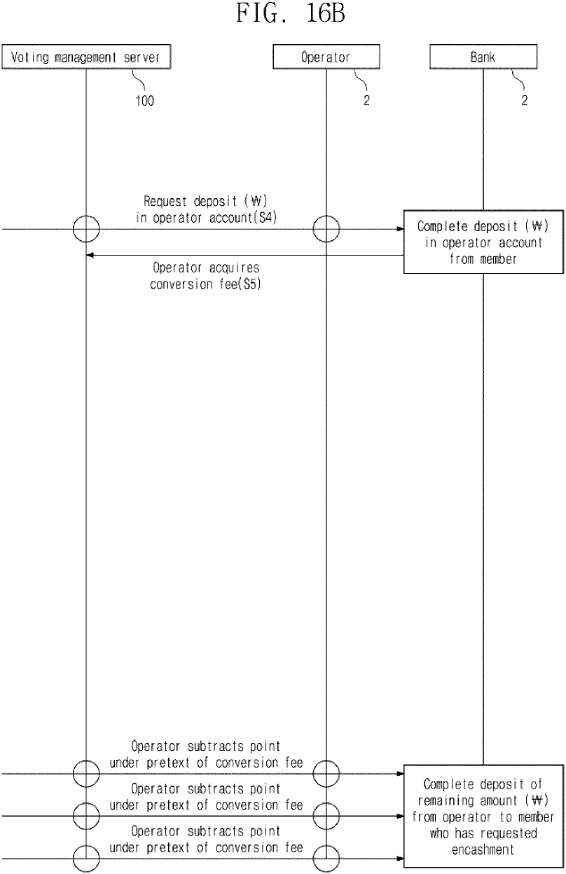

Hereinafter, a voting management program according to one embodiment of the present invention will be described with reference to FIGS. 15 and 16.

FIG. 15 is a flowchart sequentially showing steps in which a voting management program according to one embodiment of the present invention is executed, and FIGS. 16A and 16B are a reference diagram for describing a flow of points when the voting management program according to one embodiment of the present invention is executed.

As shown in FIG. 15, the voting management program according to one embodiment of the present invention may be stored in a medium in order to execute a log-in step S110, a participant status granting step S120, a chart generation step S130, and a voting result providing step S140.

First, the voting management program may execute the log-in step S110 in which a log-in unit is activated such that log-in of a participant who has registered as a member may be performed by downloading and installing a dedicated application provided from the voting management server 100 of FIG. 1.

Next, the voting management program may execute the participant status granting step S120 in which a participant status granting unit is activated such that a participant who has requested to register a question, among a plurality of participants is granted status as an inquirer. In addition, the voting management program may execute the participant status granting step S120 in which a participant status granting unit is activated such that the remaining participants except for the inquirer among the plurality of participants are granted status as an answerer.

In this case, in the participant status granting step S120, a participant who receives the status as an inquirer is granted status as an answerer with regard to other questions. In addition, in the participant status granting step S120, a participant who desires to purchase the voting result may be granted status as an answer purchaser.

Next, the voting management program may execute the chart generation step S130 in which a chart generation unit is activated such that, with regard to the question registered by the inquirer, a visually recognizable myriad answer-yield chart is generated on the basis of a result with respect to answers that have been voted for by a plurality of the answerers, within an answer range which is configured by the inquirer and allows an answer including an irrational number and in which infinite numbers consecutively exist.

In this case, in the chart generation step S130, when the answer range is set to a range from A to Z by the inquirer, first, the answer range may be equally divided into intervals i to divide the answer range into a plurality of first sections S^{a}, S^{b}, S^{c}, ..., S^{y} having the same interval i in one direction. In the chart generation step S130, S^{a} and S^{b} may be defined as a boundary point b^{a}, S^{b} and S^{c} may be defined as a boundary point b^{b}, S^{c} and S^{d} may be defined as a boundary point b^{c}, and S^{x} and S^{y} may be defined as a boundary point b^{x}. Next, in the chart generation step S130, when the at least one answer belongs to any one of the plurality of first sections S^{a}, S^{b}, S^{c}, ..., S^{y}, a first occupied area, both ends of which are defined by the numerically highest-level answer and the numerically lowest-level answer, may be displayed in the corresponding first section.

For example, in the chart generation step S130, when the answers belong to the first section S^{b}, a first occupied area O^{b}, both ends of which are defined by the numerically highest-level answer and the numerically lowest-level answer among the answers belonging to the first section S^{b}, may be displayed in the first section S^{b}.

In addition, in the chart generation step S130, when the answers belong to the first section S^{c}, a first occupied area O^{c}, both ends of which are defined by the numerically highest-level answer and the numerically lowest-level answer among the answers belonging to the first section S^{c}, may be displayed in the first section S^{c}.

In addition, in the chart generation step S130, when the answers belong to the first section S^{d}, a first occupied area O^{d}, both ends of which are defined by the numerically highest-level answer and the numerically lowest-level answer among the answers belonging to the first section S^{d}, may be displayed in the first section S^{d}.

Next, in the chart generation step S130, the representative value positions of the answers included in the corresponding first occupied area may be further displayed in the corresponding first occupied area. In this case, in the chart generation step S130, the representative value positions of the answers may be displayed in the form of a bar.

In addition, in the chart generation step S130, a concentration degree of answers indicating a distribution of answers included in the corresponding first occupied area may be further displayed in the first occupied area.

Next, in the chart generation step S130, the plurality of first sections in which the first occupied area is displayed in at least first section, that is, the answer range set by the inquirer may be designated as an X-axis of the myriad answer-yield chart, and an occurrence frequency of answers included in the first occupied area, for example, the number of answerers or an answer rate may be designated as a Y-axis of the myriad answer-yield chart.

Finally, in the chart generation step S130, the representative value positions of the answers may be schematized as a linear graph by connecting the representative value positions of the answers included in each of the first occupied areas.

Meanwhile, in the chart generation step S130, an enlarged myriad answer-yield chart for the first occupied area may be further generated. In the chart generation step S130, the first occupied area may be equally divided into intervals I′ to divide the first occupied area into a plurality of second sections S′^{a}, S′^{b}, S′^{c}, ..., S′^{y} having the same interval I′ in one direction. In the chart generation step S130, S′^{a} and S′^{b} may be defined as a boundary point b′^{a}, S′^{b} and S′^{c} may be defined as a boundary point b′^{b}, S′^{c} and S’^{d} may be defined as a boundary point b′^{c}, and S′^{x} and S′^{y} may be defined as a boundary point b′^{x}.

Next, in the chart generation step 130, when the at least one answer belongs to any one of the plurality of second sections S′^{a}, S′^{b}, S′^{c}, ..., S′^{y}, a second occupied area, both ends of which are defined by the numerically highest-level answer and the numerically lowest-level answer, may be displayed in the corresponding second section.

For example, in the chart generation step 130, when the answers belong to the second section S′^{b}, a second occupied area O′^{b}, both ends of which are defined by the numerically highest-level answer and the numerically lowest-level answer, among the answers belonging to the second section S′^{b}, may be displayed in the second section S′^{b}.

In addition, in the chart generation step 130, when the answers belong to the second section S′^{c}, a second occupied area O′^{c}, both ends of which are defined by the numerically highest-level answer and the numerically lowest-level answer among the answers belonging to the second section S′^{c}, may be displayed in the second section S′^{c}.

In addition, in the chart generation step 130, when the answers belong to the second section S’^{d}, a second occupied area O’^{d}, both ends of which are defined by the numerically highest-level answer and the numerically lowest-level answer among the answers belonging to the second section S’^{d}, may be displayed in the second section S’^{d}.

Next, in the chart generation step 130, the representative value positions of the answers included in the corresponding second occupied area may be further displayed in the corresponding second occupied area. In addition, in the chart generation step 130, a concentration degree of answers indicating a distribution of answers included in the corresponding second occupied area may be further displayed in the second occupied area.

In the chart generation step 130, the plurality of second sections in which the second occupied area is displayed in at least second section may be designated as an X-axis of the enlarged myriad answer-yield chart, and the occurrence frequency of answers included in the second occupied area may be designated as a Y-axis of the enlarged myriad answer-yield chart.

Finally, in the chart generation step 130, the representative value positions of the answers may be schematized as a linear graph by connecting the representative value positions of the answers included in each of the second occupied areas.

In this case, the voting management program may execute the interface providing step S125 in which an interface providing unit is activated such that the question registration of the inquirer and the answer registration of the answerer may be performed before executing the chart generation step S130.

In the interface providing step S125, a question window may be provided to an inquirer terminal P1 so that the question of the inquirer may be registered. The question window described herein may include a question category section 11, a question section 12, an answer range setting section 13, an answer item setting section 14, and a question condition setting section 15.

In this case, in the interface providing step S125, the question window may be provided with the answer range setting section 13 which allows setting of a minimum value and a maximum value in an infinite range including a positive number, a negative number, and an irrational number.

In one embodiment of the present invention, the inquirer may register a question by paying the retained points.

Accordingly, the voting management program may execute a point settlement step S160 in which a point settlement unit is activated such that the cashable points are subtracted from the point account of the inquirer according to the set criteria when the question of the inquirer is registered.

In addition, in the interface providing step S125, an answer window may be provided to an answerer terminal P2 so that the answer of the answerer may be registered.

The answer window described herein may include an answer section 22 including a scroll bar 22a and a number window 22b, which indicate an answer range set by the inquirer. Accordingly, the answerer may scroll the scroll bar 22a within the answer range set by the inquirer to move the scroll bar to a desired position, and may input a desired value within the answer range set by the inquirer, for example, not only a number having a decimal point that may exist in the answer range set by the inquirer, but also an irrational number such as a square root (√2) of 2 and n, into the number window 22b.

In one embodiment of the present invention, the answerer may receive the dividend amount set by the inquirer as cashable points when the answerer registers the answer.

Accordingly, the vote management program may further execute the point settlement step S160 in which the point settlement unit is activated such that the dividend amount set by the inquirer is paid to the point account of the answerer as points when the answerer registers the answer.

Finally, the voting management program may execute the voting result providing step S140 in which a voting result providing unit is activated such that the myriad answer-yield chart generated through the chart generation step S130 is provided to the participant who is willing to view the myriad answer-yield chart.

In this case, in the voting result providing step S140, the myriad answer-yield chart may be selectively provided according to the point settlement of the answer purchaser.

For example, in the voting result providing step S140, when the participant who is willing to view the voting result does not pay points for purchasing an answer, an answer distribution diagram showing a simple answer distribution may be provided to the participant terminal P (FIG. 11(a)). On the other hand, in the voting result providing step S140, when the participant who is willing to view the myriad answer-yield chart, that is, the answer purchaser, settles points for purchasing an answer, the myriad answer-yield chart generated through the chart generation step S130 may be provided to the answer purchaser terminal P3 (FIG. 11(b)).

Accordingly, the vote management program may further execute the point settlement step S160 in which the point settlement unit is activated such that the cashable points are subtracted from the point account of the answer purchaser according to the criteria set for the answer purchase, when viewing of the myriad answer-yield chart is requested.

In this case, in the point settlement step (S160), the cashable points may be accumulated in the point account of the inquirer in proportion to the cashable points subtracted from the point account of the answer purchaser. In the point settlement step S160, some or all of the cashable points subtracted from the point account of the answer purchaser may be accumulated in the point account of the inquirer.

Hereinafter, a flow of the cashable points when the voting management program according to one embodiment of the present invention will be described in more detail with respect to FIGS. 16A and 16B.

Referring to FIGS. 16A and 16B, when a participant is registered as a member through the participant terminal P (S1), membership registration information is transmitted to the voting management server 100 (S2). In this case, the participant is requested to accumulate cashable points used when the participant participates in the vote (S3), and in this case, a deposit is requested to an account of an operator 1 who operates the voting management server 100 (S4).

Accordingly, the participant may deposit an amount in the account of the operator 1 who operates the voting management server 100 through a bank 2.

When the participant has completed the deposit in the account of the operator 1 who operates the voting management server 100, the operator 1 who operates the voting management server 100 acquires a conversion fee (S5) and displays a point conversion result on a membership account after subtracting the conversion fee (S6). Accordingly, the participant is allowed to access a question window for question registration, an answer window for answer registration, and a result window for result confirmation and purchase (S7).

First, when a question generation is requested from the inquirer (S8), the voting management server 100 registers the question (S9). In this case, the dividend point payment may be set by the inquirer.

Next, when answer registration for the corresponding question is requested by the answerer (S11), the voting management server 100 may register an answer (S10).

In this case, the voting management server 100 may receive a request for receiving the set dividend points set for the answer from the answerer. Accordingly, the voting management server 100 may display point consumption due to the dividend on the inquirer terminal P1 and allow confirmation of the voting result (S12).

In addition, the voting management server 100 may display point accumulation through the answer on the answerer terminal P2 and allow confirmation of the voting result (S13).

In addition, when a result purchase is requested from the answer purchaser (S14), the voting management server 100 may subtract points set for the result purchase from an account of the answer purchaser.

In addition, the voting management server 100 may display the points consumed for purchasing the answer on the answer purchaser terminal P3 and allow the confirmation of the voting result (S16).

Meanwhile, when encashment for the points is requested from the inquirer (S17), the operator 1 who operates the voting management server 100 may subtract the points under the pretext of the conversion fee, and then may deposit the remaining amount in the account of the inquirer through the bank 2.

In addition, when encashment for the points is requested from the answerer (S18), the operator 1 who operates the voting management server 100 may subtract the points under the pretext of the conversion fee, and then may deposit the remaining amount in the account of the inquirer through the bank 2.

Further, when encashment for the points is requested from the answer purchaser (S19), the operator 1 who operates the voting management server 100 may subtract the points under the pretext of the conversion fee, and then may deposit the remaining amount in the account of the inquirer through the bank 2.

While the present invention has been described in connection with the embodiments, it is not to be limited thereto but will be defined by the appended claims. In addition, it is to be understood that those skilled in the art can substitute, change or modify the embodiments in various forms without departing from the scope and spirit of the present invention.

1. A voting management server comprising:
a participant status granting module for granting status as an inquirer to a participant who has requested to register a question, among a plurality of participants, and granting status as answerers to the remaining participants except for the inquirer;
a chart generation module for generating, with regard to the question registered by the inquirer, a visually recognizable myriad answer-yield chart on the basis of a result with respect to answers that have been voted for by a plurality of the answerers, within an answer range which is configured by the inquirer and allows an answer including an irrational number and in which infinite numbers consecutively exist; and
a voting result providing module for providing the generated myriad answer-yield chart to the participant who is willing to view same,
wherein the chart generation module divides the answer range into a plurality of first sections having a same interval in one direction by equally dividing the answer range,
when at least one answer belongs to any one of the first sections, the chart generation module displays a first occupied area, both ends of which are defined by a numerically highest-level answer and a numerically lowest-level answer, in a corresponding first section, and further displays representative value positions of answers included in the first occupied area or a concentration degree of answers indicating a distribution of the answers included in the first occupied area, in the first occupied area, and
the chart generation module designates, as an X-axis of the myriad answer-yield chart, the plurality of first sections in which the first occupied area is displayed in at least one first section, designates, as a Y-axis of the myriad answer-yield chart, an occurrence frequency of the answers included in the first occupied area, and schematizes the representative value positions of the answers as a graph by connecting the representative value positions of the answers included in each of the first occupied areas.

2. The voting management server of claim 1, wherein the chart generation module further generates an enlarged myriad answer-yield chart for the first occupied area, and divides the first occupied area into a plurality of second sections having a same interval in one direction by equally dividing the first occupied area, and
when at least one answer belongs to any one of the second sections, the chart generation module displays a second occupied area, both ends of which are defined by a numerically highest-level answer and a numerically lowest-level answer, in a corresponding second section, and further displays representative value positions of answers included in the second occupied area or a concentration degree of answers indicating a distribution of the answers included in the second occupied area, in the second occupied area.

3. The voting management server of claim 1, further comprising a point settlement module,
wherein the point settlement module includes:
an inquirer point settlement unit that subtracts cashable points from a point account of the inquirer who has the status granted by the participant status granting module according to set criteria;
an answerer point settlement unit that accumulates the cashable points in a point account of the answerer who has registered the answer to the question according to the set criteria; and
an answer purchaser point settlement unit that subtracts the cashable points from a point account of the participant who has requested to view the myriad answer-yield chart provided by the voting result providing module according to the set criteria, and accumulates the cashable points in the point account of the inquirer in proportional to the subtracted cashable points.

4. The voting management server of claim 3, wherein the voting result providing module provides the myriad answer-yield chart to the participant who has requested to view the myriad answer-yield chart, when settlement has been completed by the answer purchaser point settlement unit.

5. A voting management program stored in a computer-readable medium, the voting management program executes:
a log-in step of performing, by a log-in unit, log-in of a participant who has registered as a member by downloading and installing a dedicated application provided from a server;
a participant status granting step of granting, by a participant status granting unit, status as an inquirer to the participant who has requested to register a question, among a plurality of participants, and granting status as an answerer to remaining participants except for the inquirer;
a chart generation step of generating, with regard to the question registered by the inquirer, a visually recognizable myriad answer-yield chart on the basis of a result with respect to answers that have been voted for by a plurality of the answerers, within an answer range which is configured by the inquirer and allows an answer including an irrational number and in which infinite numbers consecutively exist; and
a voting result providing step of providing, by a voting result providing unit, the generated myriad answer-yield chart to the participant who is willing to view same,
wherein in the chart generation step, the answer range is divided into a plurality of first sections having a same interval in one direction by equally dividing the answer range,
when at least one answer belongs to any one of the first sections, a first occupied area, both ends of which are defined by a numerically highest-level answer and a numerically lowest-level answer, is displayed in a corresponding first section, and representative value positions of answers included in the first occupied area or a concentration degree of answers indicating a distribution of the answers included in the first occupied area, are further displayed in the first occupied area, and
the chart generation unit designates, as an X-axis of the myriad answer-yield chart, the plurality of first sections in which the first occupied area is displayed in at least one first section, designates, as a Y-axis of the myriad answer-yield chart, an occurrence frequency of the answers included in the first occupied area, and schematizes the representative value positions of the answers as a graph by connecting the representative value positions of the answers included in each of the first occupied areas.
